(19) United States
(12) Patent Application Publication
(10) Pub. No.: US 2022/0311632 A1
(43) Pub. Date: Sep. 29, 2022

(54) INTELLIGENT PARTICIPANT DISPLAY FOR VIDEO CONFERENCING

(71) Applicant: Avaya Management L.P., Durham, NC (US)

(72) Inventors: Navin Daga, Silapathar (IN); Sandesh Chopdekar, Pune (IN); Pushkar Yashavant Deole, Pune (IN)

(21) Appl. No.: 17/212,698

(22) Filed: Mar. 25, 2021

(51) Int. Cl. H04L 12/18; G06F 40/20; G06F 16/23

(52) U.S. Cl. CPC H04L 12/1818; H04L 12/1831; G06F 40/20; G06F 16/23

(57) ABSTRACT

The present disclosure provides, among other things, methods including: conducting a video conference over a network comprising a local node, utilized by a local participant, and remote nodes associated with remote participants; storing a result of an analysis of the video conference in a data structure comprising video conference information; and updating a data model used to automatically determine a participant decision based on the analysis of the data structure.

### FIELD OF THE DISCLOSURE

The invention relates generally to systems and methods for video conferencing and particularly to participant displays and notifications.

### BACKGROUND

Videoconferencing systems are becoming more widely used. For example, more and more work in various different sectors is done through the use of video conference calls. However, videoconferencing systems typically have fixed rules for how participants are displayed in a video conference. For example, it is typically the participant who is currently speaking who is displayed in a central portion of the screen.

### SUMMARY

There are various problems that exist with current videoconferencing systems. As one example, if a participant is on mute but the participant is relevant to the conversation, that participant may never be displayed or highlighted on the screen so that others are aware that they are participating. Also, when there are a large number of participants on a call, it can be difficult to view and locate relevant participants. This usually isn't a problem in face-to-face meetings because everyone in the meeting can see the other participants who are a part of the conversation, even if that person isn't currently talking. Another problem is being able to efficiently and effectively notify people who aren't participating in the video conference of any discussion that occurs during the video conference that is relevant to them, or being able to otherwise involve them with the video conference (e.g., by automatically inviting them to join). These problems can result in several issues, such as wasting resources (including participants' time) and causing communication issues. These problems can even lead to unsatisfactory participant experiences, such as participants feeling indifferent.

In some videoconferencing systems, an active speaker may be highlighted or a participant may be highlighted manually; however, these systems do not allow for easy highlighting of relevant participants and/or information. These systems also do not allow for easy notification of participants. Thus, while prior art practices for participant display may work well sometimes, improvements are desirable. Methods and systems disclosed herein provide for improved participant displays and/or notifications for video conferencing.

Systems and methods disclosed herein refer to a video conference having multiple participants. Participants of a video conference are persons who are connected to one another via one or more channels in order to conduct the video conference. Participants may be referred to herein as users and speakers, and include people, callers, callees, recipients, senders, receivers, contributors, humans, agents, administrators, moderators, organizers, experts, employees, members, attendees, teachers, students, and variations of these terms. Thus, in some aspects, although the embodiments disclosed herein may be discussed in terms of certain participants, the embodiments include video conferences between any type and number of users including people having any type of role or function. In addition, although participants may be engaged in a video conference, they may be using only certain channels to participate. For example, one participant may have video and audio enabled, so that other participants can both see and hear them. Another participant may have only their video enabled (e.g., they may have their microphone muted) so that other participants can only see them. Yet another participant may have only audio enabled, so that the other participants may only hear them and are not able to see them. Participants may connect to a video conference using any channel or combination of channels.

Embodiments of the present disclosure advantageously provide methods and systems that actively manage some or all of a video conference. The managing can include monitoring and analyzing, and may determine if a display and/or notifications should be managed (e.g., if changes should be made to a display and/or if a notification should be sent and/or displayed). The video conference may be monitored for any information (also referred to herein as data and attributes) related to one or more of the participants and/or the video conference itself. Information related to the participants includes and is not limited to discussion topics occurring during the video conference that relate to the participant (e.g., as defined by one or more of: key words including a participant's name, a participant's role, a task description, etc.), as well as other information (such as roles and responsibilities of a participant, external information, etc.) that relates to the participant.

As used herein, managing (and variations of the term, such as “management”) includes any managing action such as analyzing, processing, determining, deciding, comparing, updating, changing, sending, receiving, adding, removing, and/or editing. Thus, managing a video conference can include determining, configuring, changing, and/or updating one or more displays; configuring, updating, sending, and/or displaying one or more notifications; receiving a response about one or more notifications; executing actions based on the response(s); and managing the addition of one or more new participant(s) (e.g., joining one or more new participants to a video conference).

Systems and methods are disclosed herein that include monitoring a video conference to determine information about the video conference. Participant display(s) within the video conference and/or notifications related to the video conference may be managed based on the information. A participant display may be referred to herein as a screen, a layout, a configuration, and simply a display, as well as variations of these terms. A display showing information related to a participant participating in a video conference may be referred to herein as a window, a participant display, a display within a video conference, a display associated with a video conference, and variations of these terms. A participant display and/or a notification may be managed when the system detects that a change to the participant display and/or a notification is desirable. Such a detection may occur by monitoring information within the video conference. If it is determined that a participant display and/or notifications should be managed, the systems and methods may determine what type management action should be performed. The systems and methods may then manage the participant display and/or notifications to provide an improved experience for one or more participants of the video conference.

A participant of a video conference does not need to be an active or current participant of the video conference; for example, a participant may be a new (e.g., a prospective) participant who is not currently participating in the video conference. A new participant may have been a participant of the video conference previously, e.g., may have been a past participant. Thus, in some embodiments, any participant who is not currently participating in the video conference may be referred to herein as a new participant.

Participants who are relevant to a discussion occurring during a video conference may not all be speaking or otherwise active in a conversation, some of them might even be on mute; however, relevant participants are ones around which a current discussion is focused. In various embodiments, people who are deemed to be relevant to a current conversation are highlighted on the display (e.g., displayed in the center of a display, displayed with their videos or a photo shown in larger frames than the rest, and/or otherwise emphasized in the display). Managing a display for a video conference may include highlighting participants and/or other information on the display. As used herein, the term “highlighted” and variations thereof means any indicator that improves chances that something will be noticed; thus, highlighting includes and is not limited to enlarging (including enlarging a window itself, enlarging a border around a window, etc.), centering, changing color, flashing, bolding, and/or otherwise changing an appearance. Highlighting may also be referred to herein as spotlighting. Highlighting may be done for multiple elements at a same time or at any timing, and may be done automatically.

The video conference may be managed by monitoring the content (e.g., one or more conversations or discussions occurring during the video conference). Other content that may be monitored includes any communications about the video conference (e.g., audio content and visual content, including textual content and images), which can be used to determine relevant participants. Managing a video conference includes managing a display and/or managing notifications and managing a video conference may be done when changes to relevant participants are detected. Managing a participant display includes managing any information associated with the display, including and not limited to monitoring participant information such as participant video feeds, participant images, participant videos, participant names, participant contact information, and the locations and appearances of this information on the display.

Each participant in a video conference may have one or more displays of the video conference that they are viewing, and embodiments disclosed herein may manage any or all of the displays of the video conference in a similar manner (e.g., every display is managed so that the visual appearance of every display is similar to one another during the video conference). In some embodiments, less than all of the displays of the video conferenced may be managed in a similar manner. Thus, in various embodiments, different displays that are associated with the video conference may be managed differently from one another. The display management may be based on properties of a communication device in addition to properties of the video conference, including screen size, number of participants, type of highlighting desired by a user, etc. In methods and systems disclosed herein, managing a participant display may be performed with user involvement, or may be performed automatically, without any human interaction.

Embodiments of the present disclosure can improve video conference experiences by changing how displays and/or notifications are implemented. Artificial intelligence (AI), including the utilization of machine learning (ML), can be used in various aspects disclosed herein. Embodiments of the present disclosure describe fully-automated solutions and partially- automated solutions that permit real-time insights from Artificial Intelligence (“AI”) applications, and other sources, to adjust the participant display and/or to send notifications for a video conference. For example, artificial intelligence may manage the participant display and highlight relevant participants at any point of time during the video conference and may also manage notifications at any point of time during the video conference. In some embodiments, Natural Language Processing (NLP) can be used to manage the video conference.

Artificial intelligence, as used herein, includes machine learning. Artificial intelligence and/or user preference can configure displays and/or notifications, as well as the information that is used to manage video conferences. For example, artificial intelligence and/or user preference can determine which information is compared to content in order to determine management of a video conference. Artificial intelligence and/or user preference may also be used to configure user profile(s) and/or settings, which may be used when managing displays and/or notifications by comparing information associated with the video conference to information about one or more users.

Some embodiments utilize natural language processing (NLP) in the methods and systems disclosed herein. For example, machine learning models can be trained to learn what information is relevant to a user, a discussion topic, and/or other information. Machine learning models can have access to resources on a network and access to additional tools to perform the systems and methods disclosed herein. The additional tools can include project development and collaboration tools including calendar applications, Jira Software and Confluence, change management software including Rational ClearQuest (Rational CQ), and quality management software, to name a few.

In certain embodiments, data mining and machine learning tools and techniques will discover information used to determine content relevance. Thus, in some embodiments, data mining and machine learning tools and techniques can discover properties about the video conference that can inform improvements for displays and notifications for each video conference session. For example, data mining and machine learning tools and techniques can discover user information, user preferences, key word(s) and/or phrases, and display and notification configurations, among other embodiments, to inform an improved video conferencing experience.

Machine learning may manage one or more types of information (e.g., user information, communication information, etc.), types of content (including different portions of content within a video conference), comparisons of information, settings related to users and/or user devices, and organization (including formatting of displays and notifications). Machine learning may utilize all different types of information. Machine learning may determine variables associated with information, and compare information in order to determine relevant participants and their associated information. Any of the information and/or outputs may be modified and act as feedback to the system.

Historical information may be used to determine if a participant display and/or notifications should be managed, and in some embodiments a comparison of monitored information to historical information is used to determine if a participant display and/or notifications should be managed. Historical information may be provided from any source, including by one or more users and by machine learning.

Further embodiments interface with memory components, which may include external systems (e.g., external databases, repositories, etc.) to obtain information relevant to the video conference, including information relevant to participants of the video conference. Such information may be stored in one or more data structures. As used herein, the term “data structure” includes in-memory data structures that may include records and fields. Data structures may be maintained in memory, a data storage device, and/or other component(s) accessible to a processor.

For example, if a particular list of issues is discussed that relate to information within an external central repository (e.g., a list of roles, responsibilities, assigned action items, to-do lists, and/or other information associated with the video conference or participants, including new participants, of the video conference), then the methods and systems disclosed herein can access the external information, and search for and obtain relevant information from the external information in order to use the relevant information in the embodiments described herein.

Methods described or claimed herein can be performed with traditional executable instruction sets that are finite and operate on a fixed set of inputs to provide one or more defined outputs. Alternatively, or additionally, methods described or claimed herein can be performed using AI, machine learning, neural networks, or the like. In other words, a system is contemplated to include finite instruction sets and/or artificial intelligence-based models/neural networks to perform some or all of the steps described herein.

As one illustrative example, a first participant may ask a question and then go on mute and a second participant can answer the question after the first participant is on mute; however, both the first participant and the second participant can be highlighted while the question is being answered. Alternatively, only the second participant may be highlighted at any time while the question is being asked and answered. Also, if there are multiple participants participating in a discussion and only one participant (or not all participants) is talking at a time, then every one of the multiple participants may all be highlighted at a same time while they are participating in the discussion, so that even the participants who are not talking currently may remain highlighted while the discussion is occurring.

As another illustrative example, if one participant is giving instructions to another participant then both participants may be highlighted or only the participant receiving the instructions may be highlighted. One or more participants can be highlighted even if they are on mute (e.g., have their microphone(s) on mute). In addition, if a participant's name is being called, then that participant may be brought to the spotlight.

In various embodiments, notifications may be managed without any indication or change to the display (e.g., a notification may be sent to a new participant that informs them of the current discussion occurring in the video conference that is relevant to them). In methods and systems disclosed herein, managing notifications may be performed with user involvement, or may be performed automatically, without any human interaction. Notifications may be referred to herein as alerts, requests, and invites, and variations of these terms.

In some aspects, methods and systems described herein are applicable to one or more participants who are not currently connected to the video conference. For example, if a new participant is being discussed in the meeting but the new participant is not dialed into the video conference at the time they are referenced (e.g., a new participant is referred to by a first participant speaking to a second participant during the video conference who says “you may talk to the new participant for this issue”), then the display and/or notifications may be managed based on the reference to the new participant. In some aspects, if an image of the new participant is available, then it may be highlighted in the display together with the new participant's name and contact information, if available, so that the other participants in the call are better informed about who to talk to or who is being discussed. In other aspects, a notification for the new participant may be managed; for example, a notification may be automatically sent to the new participant to notify the new participant that the discussion is occurring, and any other information related to the discussion, a notification containing an invitation to join the video conference may be automatically sent to the new participant, and/or a notification may be configured to be presented on the display. Any notification options may be automatic or may involve human interaction. In various aspects, any information or combination of information about a new participant (or multiple new participants) may be displayed or highlighted during the video conference, such as an identification photo, a title, a phone number, an email address, etc.

In various embodiments, if one or more new participant(s) is referenced during a video conference, then the methods and systems described herein could provide a notification to the new participant and/or an invitation to participate in the video conference. For example, methods and systems described herein may send one or more notifications to the new participant(s), together with a context and topic in which their name was referenced in the video conference. The notifications may be configured in any manner, may be configured by the methods and systems disclosed herein (including automatically and/or through the use of artificial intelligence), may be configured by one or more users, and may contain any one or more types of information (e.g., textual information, audio information, video information, image information).

In some embodiments, methods and systems disclosed herein could provide one or more participants associated with the video conference with an option to inform the new participant(s) of the video conference, or of a portion of (e.g., a relevant portion of) or an entirety of the discussion of the video conference. In some aspects, the new participant(s) may be invited to join the video conference, they may be sent details of the relevant discussion content, and/or they may be sent a request to provide input to the discussion. If a new participant selects to join a video conference, or to provide input to the video conference, these actions may be executed automatically by the methods and systems described herein.

In some embodiments, the methods and systems disclosed herein may obtain the external information and display the information for the relevant participant(s) by highlighting the information during the video conference. In various aspects, the methods and systems can determine one or more relevant participants by accessing and analyzing relevant external information together with analyzing how the relevant participants should be managed, including by highlighting the relevant participant(s), while the relevant external information is being discussed. For example, methods and systems as described herein may determine which participant(s) are related to the information being discussed by accessing relevant data structure(s) and analyzing the information associated with the discussion (e.g., using an analysis of the words spoken in the discussion and any textual information discussed or shown in the discussion) in order to determine the participant(s) who are relevant to the information being discussed. The relevant participants may be highlighted during the information being discussed and/or notifications may be sent to the relevant participants.

In various embodiments, any user may manage a participant display and notifications. For example, a user may choose configuration settings for how a display is to be configured, including how content in the display should be highlighted in accordance with the embodiments described herein. A user may also choose settings for how notifications are sent and received, as well as any desired content of the notifications. Users may configure displays and/or notifications at any point in time before or during the video conference. As one illustrative example, a link (or options) to manage a notification may be displayed or highlighted on the display and users may manage sending of a notification by selecting (e.g., clicking on) the link (or options).

Various embodiments disclosed herein are advantageous because one or more participants do not need to be involved, or even aware of, changes to the display and/or notifications. In other words, the displays and/or notifications may be managed automatically without participant involvement, thereby saving resources while improving the video conferencing experience and improving communications. Even in embodiments where the displays and/or notifications are managed only partly automatically (e.g., with some human interaction), these embodiments are likewise advantageous because they may also save resources while improving the video conferencing experience and improving communications.

Embodiments disclosed herein provide for improved participant displays and/or notifications for video conferencing. The improved displays and/or notifications can advantageously increase participant interaction for a video conference, as well as improve communications and reduce misunderstandings. Different embodiments may be advantageous in different situations. For example, various embodiments may advantageously be used in online teaching for interaction between the teacher and students, or interactions between students (e.g., when a student is asked a question by the teacher, the student can be brought to spotlight immediately).

According to some aspects of the present disclosure, systems include: at least one processor; a memory; and a network interface to enable the at least one processor to communicate via a network; where the at least one processor: conducts a video conference as a node on the network and communicates via the network with communication devices associated with remote participants; stores a result of an analysis of the video conference in a data structure including video conference information; and updates a data model used to automatically determine a participant decision based on the analysis of the data structure.

In some embodiments, the analysis of the video conference is an analysis of a conversation occurring during the video conference, where the result is a participant identification; and where the at least one processor: identifies one of the remote participants based on the participant identification, where the participant decision is highlighting; and highlights, based on the participant decision, the one of the remote participants in a participant display on at least one of the communication devices.

In some embodiments, the analysis of the video conference is an analysis of a conversation occurring during the video conference, where the result is at least two relevant participants; and where the participant decision includes displaying a view associated with the at least two relevant participants.

In some embodiments, the conversation is a verbal conversation.

In some embodiments, the analysis of the conversation includes Natural Language Processing.

In some embodiments, the Natural Language Processing identifies the at least two relevant participants.

In some embodiments, the view highlights the at least two relevant participants.

In some embodiments, at least one of the at least two relevant participants is muted when highlighted in the view.

In some embodiments, at least one window displaying the at least two relevant participants is highlighted by at least one of: resizing a size of the at least one window in the view; and changing a position of the at least one window in the view.

In some embodiments, the at least two relevant participants is highlighted by being enlarged in the view.

In some embodiments, the participant decision is sending a notification to a new participant.

In some embodiments, the result is information that is external to the video conference; where the at least one processor determines a relevant participant based on the information that is external, and where the participant decision includes displaying a view highlighting the relevant participant.

In some embodiments, the participant decision is determining if a participant display is different from a current participant display; and when the participant display is different from the current participant display, displays the participant display.

In some embodiments, the analysis of the video conference is an analysis of a conversation occurring during the video conference, where the result is a participant identification; where the at least one processor identifies a new participant based on the participant identification, where the new participant is not one of the remote participants, and where the participant decision includes including information associated with the new participant in a participant display.

In some embodiments, the analysis of the video conference includes a first analysis of a first portion of a conversation occurring during the video conference, where the result includes at least a first relevant participant; the analysis of the video conference includes a second analysis of a second portion of the conversation occurring during the video conference, where the result includes at least a set of second relevant participants; a participant display includes a first view associated with the at least the first relevant participant during the first portion of the conversation and a second view associated with the at least the set of second relevant participants during the second portion of the conversation; at least one of the participants of the at least a first relevant participant is different than each participant in the set of second relevant participants; and the participant decision includes displaying the first view during the first portion of the conversation and displaying the second view during the second portion of the conversation.

According to some aspects of the present disclosure, methods include: conducting a video conference over a network including a local node, utilized by a local participant, and remote nodes associated with remote participants; storing a result of an analysis of the video conference in a data structure including video conference information; and updating a data model used to automatically determine a participant decision based on the analysis of the data structure.

In some embodiments, the analysis of the video conference is an analysis of a conversation occurring during the video conference, where the result is a participant identification; and further including: identifying one of the remote participants based on the participant identification, where the participant decision includes highlighting the one of the remote participants in a participant display on at least one of the communication devices.

In some embodiments, the analysis of the video conference is an analysis of a conversation occurring during the video conference, where the result is at least two relevant participants; and where the participant decision includes displaying a view associated with the at least two relevant participants.

According to some aspects of the present disclosure, systems include: enabling a machine learning process to analyze the data structure, where the analysis of the data structure is done by the machine learning process.

According to some aspects of the present disclosure, methods include: means to conduct a video conference as a node on the network and communicate via the network with communication devices associated with remote participants; means to store a result of an analysis of the video conference in a data structure includes video conference information; and means to update a data model used to automatically determine a participant decision based on the analysis of the data structure.

According to some aspects of the present disclosure, systems include: at least one processor; a memory; and a network interface to enable the at least one processor to communicate via a network; where the at least one processor: conducts a video conference as a node on the network and communicates via the network with communication devices associated with remote participants; stores a result of an analysis of the video conference in a data structure including video conference information; enables a machine learning process to analyze the data structure; and updates a data model used to automatically determine a participant decision based on the analysis of the data structure by the machine learning process.

In some embodiments, the analysis of the video conference is an analysis of a conversation occurring during the video conference, the result is a participant identification; and the at least one processor: identifies one of the remote participants based on the participant identification, where the participant decision is highlighting; and highlights, based on the participant decision, the one of the remote participants in a participant display on at least one of the communication devices.

In some embodiments, the analysis of the video conference is an analysis of a conversation occurring during the video conference, the result is at least two relevant participants; and the participant decision includes displaying a view associated with the at least two relevant participants.

In some embodiments, the conversation is a verbal conversation.

In some embodiments, the analysis of the conversation includes Natural Language Processing.

In some embodiments, the Natural Language Processing identifies the at least two relevant participants.

In some embodiments, the view highlights the at least two relevant participants.

In some embodiments, the at least one of the at least two relevant participants is muted when highlighted in the view.

In some embodiments, at least one window displaying the at least two relevant participants is highlighted by at least one of: resizing a size of the at least one window in the view; and changing a position of the at least one window in the view.

In some embodiments, the at least two relevant participants is highlighted by being enlarged in the view.

In some embodiments, the participant decision is sending a notification to a new participant.

In some embodiments, the result is information that is external to the video conference; the at least one processor determines a relevant participant based on the information that is external, and the participant decision includes displaying a view highlighting the relevant participant.

In some embodiments, the participant decision is determining if a participant display is different from a current participant display; and when the participant display is different from the current participant display, displays the participant display.

In some embodiments, the analysis of the video conference is an analysis of a conversation occurring during the video conference, the result is a participant identification; the at least one processor identifies a new participant based on the participant identification, the new participant is not one of the remote participants, and the participant decision includes information associated with the new participant in a participant display.

In some embodiments, the analysis of the video conference includes a first analysis of a first portion of a conversation occurring during the video conference, the result includes at least a first relevant participant; the analysis of the video conference includes a second analysis of a second portion of the conversation occurring during the video conference, the result includes at least a set of second relevant participants; a participant display includes a first view associated with the at least the first relevant participant during the first portion of the conversation and a second view associated with the at least the set of second relevant participants during the second portion of the conversation; at least one of the participants of the at least a first relevant participant is different than each participant in the set of second relevant participants; and the participant decision includes displaying the first view during the first portion of the conversation and displaying the second view during the second portion of the conversation.

According to some aspects of the present disclosure, methods include: conducting a video conference over a network including a local node, utilized by a local participant, and remote nodes associated with remote participants; storing a result of an analysis of the video conference in a data structure including video conference information; enabling a machine learning process to analyze the data structure; and updating a data model used to automatically determine a participant decision based on the analysis of the data structure by the machine learning process.

In some embodiments, the analysis of the video conference is an analysis of a conversation occurring during the video conference, the result is a participant identification; and further including: identifying one of the remote participants based on the participant identification, where the participant decision includes highlighting the one of the remote participants in a participant display on at least one of the communication devices.

In some embodiments, the analysis of the video conference is an analysis of a conversation occurring during the video conference, the result is at least two relevant participants; and the participant decision includes displaying a view associated with the at least two relevant participants.

In some embodiments, the analysis of the video conference is an analysis of a conversation occurring during the video conference, the result is a participant identification; and further including: identifying a new participant based on the participant identification, where the new participant is not one of the remote participants, and where the participant decision includes displaying information associated with the new participant in a participant display.

According to some aspects of the present disclosure, systems include: means to conduct a video conference as a node on the network and communicate via the network with communication devices associated with remote participants; means to store a result of an analysis of the video conference in a data structure including video conference information; means to enable a machine learning process to analyze the data structure; and means to update a data model used to automatically determine a participant decision based on the analysis of the data structure by the machine learning process.

According to some aspects of the present disclosure, systems include: at least one processor with a memory; and a network interface to enable the at least one processor to communicate via a network; where the at least one processor: conducts a video conference as a node on the network and communicates via the network with communication devices associated with remote participants; stores a result of an analysis of the video conference in a database including video conference information; enables a machine learning process to analyze the database; and updates a data model used to automatically determine a participant display within the video conference based on the analysis of the database by the machine learning process.

In some embodiments, the analysis of the video conference is an analysis of a conversation occurring during the video conference, the result is a participant identification; and the at least one processor: identifies one of the remote participants based on the participant identification; and highlights the one of the remote participants in the participant display on at least one of the communication devices.

In some embodiments, the analysis of the video conference is an analysis of a conversation occurring during the video conference, the result is at least two relevant participants; and the participant display includes a view associated with the at least two relevant participants.

In some embodiments, the conversation is a verbal conversation.

In some embodiments, the analysis of the conversation includes Natural Language Processing.

In some embodiments, the Natural Language Processing identifies the at least two relevant participants.

In some embodiments, the view highlights the at least two relevant participants.

In some embodiments, at least one of the at least two relevant participants is muted when highlighted in the view.

In some embodiments, the at least two relevant participants is highlighted by being centered in the view.

In some embodiments, the at least two relevant participants is highlighted by being enlarged in the view.

In some embodiments, the result is information that is external to the video conference; the at least one processor determines a relevant participant based on the information that is external, and the participant display includes a view highlighting the relevant participant.

In some embodiments, the at least one processor: determines if the participant display is different from a current participant display; and when the participant display is different from the current participant display, displays the participant display.

In some embodiments, the analysis of the video conference is an analysis of a conversation occurring during the video conference, the result is a participant identification; the at least one processor identifies a new participant based on the participant identification, the new participant is not one of the remote participants, and includes information associated with the new participant in the participant display.

In some embodiments, the analysis of the video conference includes a first analysis of a first portion of a conversation occurring during the video conference, the result includes at least a first relevant participant; the analysis of the video conference includes a second analysis of a second portion of the conversation occurring during the video conference, the result includes at least a set of second relevant participants; the participant display includes a first view associated with the at least the first relevant participant during the first portion of the conversation and a second view associated with the at least the set of second relevant participants during the second portion of the conversation; at least one of the participants of the at least a first relevant participant is different than each participant in the set of second relevant participants; and the at least one processor displays the first view during the first portion of the conversation and displays the second view during the second portion of the conversation.

According to some aspects of the present disclosure, methods include: conducting a video conference over a network including a local node, utilized by a local participant, and remote nodes associated with remote participants; storing a result of an analysis of the video conference in a database including video conference information; enabling a machine learning process to analyze the database; and updating a data model used to automatically determine a participant display within the video conference based on the analysis of the database by the machine learning process.

In some embodiments, where the analysis of the video conference is an analysis of a conversation occurring during the video conference, the result is a participant identification; and further including: identifying one of the remote participants based on the participant identification; and highlighting the one of the remote participants in the participant display on at least one of the communication devices.

In some embodiments, the analysis of the video conference is an analysis of a conversation occurring during the video conference, the result is at least two relevant participants; and the participant display includes a view associated with the at least two relevant participants.

In some embodiments, the result is information that is external to the video conference; further including determining a relevant participant based on the information that is external, and where the participant display includes a view highlighting the relevant participant.

In some embodiments, the analysis of the video conference is an analysis of a conversation occurring during the video conference, the result is a participant identification; and further including: identifying a new participant based on the participant identification, where the new participant is not one of the remote participants; and including information associated with the new participant in the participant display.

According to some aspects of the present disclosure, systems include: means to conduct a video conference as a node on the network and communicate via the network with communication devices associated with remote participants; means to store a result of an analysis of the video conference in a database including video conference information; means to enable a machine learning process to analyze the database; and means to update a data model used to automatically determine a participant display within the video conference based on the analysis of the database by the machine learning process.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

FIG. 1 shows an illustrative first system in accordance with various embodiments of the present disclosure;

FIG. 2 shows an illustrative second system in accordance with various embodiments of the present disclosure;

FIG. 3 shows an illustrative third system in accordance with various embodiments of the present disclosure;

FIG. 4 shows an illustrative first display in accordance with various embodiments of the present disclosure;

FIG. 5 shows an illustrative second display in accordance with various embodiments of the present disclosure;

FIG. 6 shows an illustrative third display in accordance with various embodiments of the present disclosure;

FIG. 7A shows an illustrative fourth display in accordance with various embodiments of the present disclosure;

FIG. 7B shows an illustrative fifth display in accordance with various embodiments of the present disclosure;

FIG. 7C shows an illustrative sixth display in accordance with various embodiments of the present disclosure;

FIG. 8 shows an illustrative first process in accordance with various embodiments of the present disclosure; and

FIG. 9 shows an illustrative second process in accordance with various embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

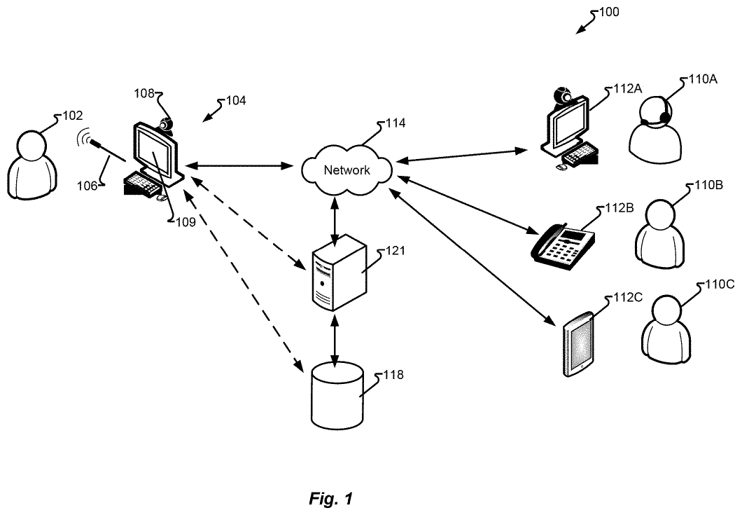

FIG. 1 depicts system 100 in accordance with embodiments of the present disclosure. . In some aspects, the components shown in FIG. 1 may correspond to like components discussed in other figures disclosed herein.

In some embodiments, a video conference is (or will be) conducted between local participant 102 utilizing local node 104 and a number of remote participants 110 utilizing a number of remote nodes 112. Local node 104 may include one or more user input-output devices including, microphone 106, camera 108, display 109 and/or other component. In one embodiment, the only participant is local participant 102, such as prior to the video conference being joined by at least one other remote participant 110. An image of local participant 102 may be captured with camera 108 and/or speech from local participant 102 may be captured by microphone 106 to participate in the video conference. One or more remote participant 110, via their respective remote node 112, may participate in the video conference utilizing, at least, network 114. Network 114 may be one or more data networks and include, but not limited to, the internet, WAN/LAN, WiFi, telephony (plain old telephone system (POTS), session initiation protocol (SIP), voice over IP (VoIP), cellular, etc.), or other network or combinations thereof when enabled to convey audio video data of a video conference.

Communication server 121 may include one or more processors managing the video conference, such as floor control, adding/dropping participants, changing displays for one or more participants, moderator control, etc. Communication server 121, and the one or more processors, may further include one or more hardware devices utilized for data processing (e.g., cores, blades, stand-alone processors, etc.) with a memory incorporated therein or accessible to the one or more processors. Non-limiting examples of communication protocols or applications that may be supported by the communication server 121 include webcast applications, the Session Initiation Protocol (SIP), File Transfer Protocol (FTP), Hypertext Transfer Protocol (HTTP), HTTP secure (HTTPS), Transmission Control Protocol (TCP), Java, Hypertext Markup Language (HTML), Short Message Service (SMS), Internet Relay Chat (IRC), Web Application Messaging (W AMP), SOAP, MIME, Real-Time Messaging Protocol (RTP), Web Real-Time Communications (WebRTC), WebGL, XMPP, Skype protocol, AIM, Microsoft Notification Protocol, email, etc.

Data storage device 118 provides accessible data storage to the one or more processors, such on a network storage device, internal hard drive, platters, disks, optical media, magnetic media, and/or other non-transitory device or combination thereof. System 100 may be embodied as illustrated where communication server 121 and data storage device 118 are distinct from local node 104. In other embodiments, one or both of communication server 121 and data storage device 118 may be provided by local node 104 or via direct or alternate data channel when not integrated into local node 104.

Remote participant 110 may utilize remote node 112 which is variously embodied. While a video conference may preferably have each remote participant 110 utilize a camera, microphone, and display operable to present images from the video conference, this may not be required. For example, remote participant 110B may utilize remote node 112B embodied as an audio-only telephone. Accordingly, the video conference may omit any image of remote participant 110B or utilize a generated or alternate image, such as a generic image of a person. With respect to the embodiments that follow, the video conference includes audio-video information from and to local node 104 and more generally to embodiments where audio-video information is further provided to and from at least one remote node 112.

It should be appreciated that local node 104 may be or include an input-output device. In other embodiments, input-output devices may be integrated into local node 104 or attached as peripheral devices (e.g., attached microphone 106, attached camera 108, etc.) or other devices having a combination of input-output device functions, such as a camera with integrated microphone, headset with microphone and speakers, etc., without departing from the scope of the embodiments herein.

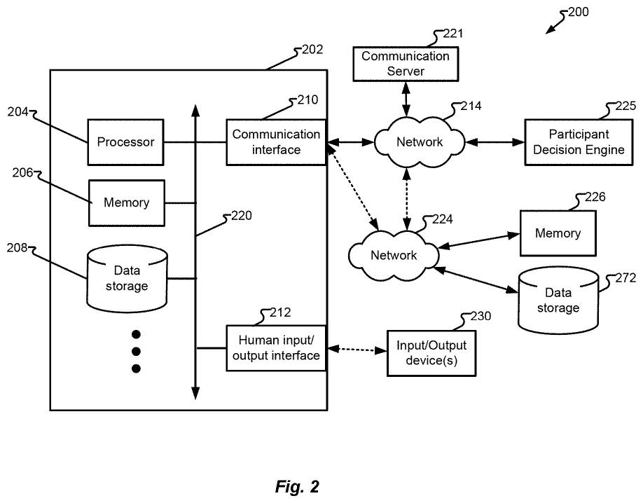

FIG. 2 depicts system 200 in accordance with embodiments of the present disclosure. In some aspects, the components shown in FIG. 2 may correspond to like components discussed in other figures disclosed herein.

In some embodiments, local node 104 may be embodied, in whole or in part, as device 202 including various components and connections to other components and/or systems. The components are variously embodied and may include processor 204. Processor 204 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.), execute instructions, and output data.

In addition to the components of processor 204, device 202 may utilize memory 206 and/or data storage 208 for the storage of accessible data, such as instructions, values, etc. Communication interface 210 facilitates communication with components. Communication interface 210 may be embodied as a network port, card, cable, or other configured hardware device. Additionally, or alternatively, input/output interface 212 connects to one or more interface components to receive and/or present information (e.g., instructions, data, values, etc.) to and/or from a human and/or electronic device. Examples of input/output devices 230 that may be connected to input/output interface include, but are not limited to, keyboard, mouse, trackball, printers, displays, sensor, switch, relay, etc. In another embodiment, communication interface 210 may include, or be included by, input/output interface 212. Communication interface 210 may be configured to communicate directly with a networked component or utilize one or more networks, such as network 214 and/or network 224.

Network 114 may be embodied, in whole or in part, as network 214. Network 214 may be a wired network (e.g., Ethernet), wireless (e.g., WiFi, Bluetooth, cellular, etc.) network, or combination thereof and enable device 202 to communicate with participant decision engine 225.

Additionally, or alternatively, one or more other networks may be utilized. For example, network 224 may represent a second network, which may facilitate communication with components utilized by device 202 Components attached to network 224 may include memory 226, data storage 272, input/output device(s) 230, and/or other components that may be accessible to processor 204. For example, memory 226 and/or data storage 272 may supplement or supplant memory 206 and/or data storage 208 entirely or for a particular task or purpose. For example, memory 226 and/or data storage 272 may be an external data repository (e.g., server farm, array, “cloud,” etc.) and allow device 202, and/or other devices, to access data thereon. Similarly, input/output device(s) 230 may be accessed by processor 204 via input/output interface 212 and/or via communication interface 210 either directly, via network 224, via network 214 alone (not shown), or via networks 224 and 214.

It should be appreciated that computer readable data may be sent, received, stored, processed, and presented by a variety of components. It should also be appreciated that components illustrated may control other components, whether illustrated herein or otherwise. For example, one input/output device 230 may be a router, switch, port, or other communication component such that a particular output of processor 204 enables (or disables) input/output device 230, which may be associated with network 214 and/or network 224, to allow (or disallow) communications between two or more nodes on network 214 and/or network 224. In various embodiments, other communication equipment may be utilized, in addition or as an alternative, to those described herein without departing from the scope of the embodiments.

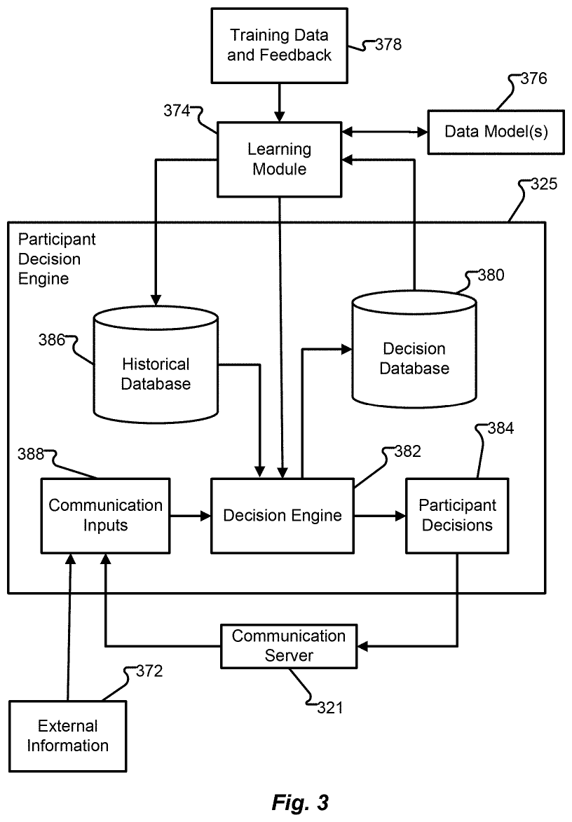

FIG. 3 is a block diagram depicting additional illustrative details of a participant decision engine in accordance with at least some embodiments of the present disclosure. In some aspects, the components shown in FIG. 3 may correspond to like components shown in other figures disclosed herein. In FIG. 3, a participant decision engine 325 interacts with a communication server 321, external information 372, and a learning module 374. The learning module 374 receives input from training data and feedback 378 and sends and receives information from data model(s) 376. The participant decision engine 325 includes a historical database 386, a decision database 380, a communication inputs 388, a decision engine 382, and participant decisions 384.

The learning module 374 may utilize machine learning and have access to training data and feedback 378 to initially train behaviors of the learning module 374. Training data and feedback 378 contains training data and feedback data that can be used for initial training of the learning module 374. The learning module 374 may be configured to learn from other data, such as any events or message exchanges based on feedback, which may be provided in an automated fashion (e.g., via a recursive learning neural network and/or a recurrent neural network) and/or a human-provided fashion (e.g., by one or more users). The learning module 374 may additionally utilize training data and feedback 378. For example, the learning module 374 may have access to one or more data model(s) 376 and the data model(s) 376 may be built and updated by the learning module 374 based on the training data and feedback 378. The data model(s) 376 may be provided in any number of formats or forms. Non-limiting examples of data model(s) 376 include Decision Trees, Support Vector Machines (SVMs), Nearest Neighbor, and/or Bayesian classifiers.

The learning module 374 may also be configured to access information from a decision database 380 for purposes of building a historical database 386. The decision database 380 stores data related to video conferences, including but not limited to historical participant information, historical participant decisions, historical display information, display processing history, historical notification decisions, historical notification information, notification processing history, historical managing decisions, etc. Information within the historical database 386 may constantly be updated, revised, edited, or deleted by the learning module 374 as the participant decision engine 325 processes additional information and management decisions.

In some embodiments, the participant decision engine 325 may include a decision engine 382 that has access to the historical database 386 and selects appropriate participant decisions 384. Participant decisions 384 include, for example, display managing decisions based on input from the historical database 386 and based on communication inputs 388 received from the communication server 321 and/or external information 372. Participant decisions 384 include, for example, notification decisions based on input from the historical database 386 and based on communication inputs 388 received from the communication server 321 and/or external information 372. As described herein, the participant decision engine 325 may manage participant decisions 384 and in some embodiments, notifications may be managed separately from display management (e.g., a notification may be managed without any changes to a display, including sending information to a new participant, sending an invitation to join to a new participant, etc.), while in other embodiments they may be managed in conjunction with one another (e.g., a display may show that a notification has been or is being sent, a display may display information related to a notification and/or request a confirmation to send a notification, etc.). In some aspects, a notification message may be sent (e.g., as a text message, an email, and/or any other type of communication) to a new participant where the notification includes a context explaining how the new participant was mentioned in the video conference (e.g., a subject of the discussion in which the new participant was discussed during the video conference may be included in the notification to the new participant).

The participant decision engine 325 may receive communication inputs 388 in the form of external information 372, real-time communication data from the communication server 321, and/or other communication information from the communication server 321. Other communication information may include information related to communication data, information related to communication devices (e.g., microphone settings, screen size, configuration settings, etc.), and/or participant information, among others. The decision engine 382 may manage displays and notifications based on any of the criteria described herein, and using inputs from communication server 321 and external information 372 (via communication inputs 388), historical database 386, and/or learning module 374. The decision engine 382 may receive information about one or more communications (e.g., video conferences) and analyze the information to determine management decisions that are sent to decision database 380 and/or participant decisions 384. The decision engine 382 may determine information about discussion occurring during video conferences (e.g., based on natural language processing), and/or any other aspects of the video conference, such as a current display configuration, display settings, etc.

The participant decision engine 325 may monitor a video conference for information that determines one or more relevant participants as they pertain to the current discussion or events in the video conference. For example, participant decision engine 325 may monitor for any mention of words such as participant names or other key words, and may use Natural Language Processing to analyze the context of the detected words. The participant decision engine 325 may use other information, such as information from a task repository, to determine which participants are relevant participants for the discussion currently occurring. The participant decision engine 325 may determine a configuration of a display for the video conference to determine if the display should be changed to show any of the identified relevant participants or other information (e.g., contact information, a moderator's picture, a moderator's video, etc.). In some embodiments, the participant decision engine 325 may compare one or more properties of a first display configuration with one or more properties of a second display configuration (where the first display configuration is what is being currently displayed in the video conference, and the second display configuration is one showing participants deemed to be relevant). If there are differences in the display configurations (e.g., participants being currently highlighted are not participants determined to be relevant to the current discussion occurring), then the participant decision engine 325 may change the display so that the relevant participants are shown. Thus, the participant decision engine 325 can advantageously maintain the highlighting of only participants who are relevant to the current discussion happening in the video conference.

To enhance capabilities of the decision engine 382, the decision engine 382 may constantly be provided with training data and feedback 378 from communications. Therefore, it may be possible to train a decision engine 382 to have a particular output or multiple outputs. In various embodiments, the output of an artificial intelligence application (e.g., learning module 374) is an updated participant display that is sent via the decision engine 382, and from participant decisions 384, to the communication server 321. Outputs can also include notifications and other information that is sent via the decision engine 382, and from participant decisions 384, to the communication server 321. Using the communication inputs 388 and the historical database 386, the participant decision engine 325 may be configured to provide participant decisions 384 (e.g., one or more display configurations and/or notifications) to the communication server 321. The participant decisions 384 may update one or more participant displays for one or more communication sessions and/or manage notifications.

In various embodiments, there can be little or no manual configuration of the participant displays and participant displays may be managed on an ad hoc basis. For example, an artificial intelligence application may be enabled to integrate with the systems and methods described herein in order to advantageously determine and implement changes to participant displays. Such embodiments are advantageous by automating and quickly adjusting (with little or no manual configuration) participant displays in order to improve user experience and save resources (e.g., save users' time).

In some embodiments, the participant decision engine 325 may be implemented as follows. The communication server 321 may serve a plurality of nodes (e.g., user endpoints) and there can be a plurality of communications occurring between the communication server 321 and user endpoints, including video conferencing communication sessions. A new video conference session is initiated and relayed by communication server 321 to communication inputs 388. Communication inputs 388 may also have received information about accessing a data structure containing information about participants of the communication sessions as they relate to task data. The decision engine 382 analyzes the discussion occurring during the video conference (e.g., using artificial intelligence) and determines that certain tasks are being discussed during the video conference. The decision engine 382 obtains information related to the tasks being discussed from external information 372 and determines that a subset of participants of the video conference are responsible for the tasks and that this subset of participants should be highlighted during the video conference, even if one or more of the participants is not speaking, is on mute, and/or does not have a video feed displaying in the video conference. The decision engine 382 provides this decision to the participant decisions 384 to manage the display of the participants during the video conference, and the subset of participants is highlighted, by the participant decision engine 325, on the displays of the participants. The participant decision engine 325 continues monitoring the video conference to determine if further management is needed, as described herein.

The external information 372, may include information about participants of the new video conference, such as user profile information. Information about a video conference, together with the external information 372, may be sent to the decision engine 382 where it is analyzed. The decision engine 382 may analyze the audio information from the video conference by processing, in real time, the conversations in the audio information. The decision engine 382 may also analyze the video feed from the video conference by processing, in real time, the images shown in the video information. For example, current speakers can be determined from the audio feed as well as topics of conversation. The external information may be used in the analysis done by the decision engine 382 to determine changes to the participant display of the video conference. In some embodiments, artificial intelligence is used to analyze the audio and or video information together with the external information 372 in order to determine changes to the participant display.

Based on the analysis, the decision engine 382 sends participant display changes to the participant decisions 384. The participant display may be changed in any manner, and may change any number of times during a video conference as the information in the video conference changes. The participant display may advantageously change in real time to show the participants in the video conference who are currently part of the discussion occurring in real time, even if they are not speaking or are on mute.

In some embodiments, the decision engine 382 can display information other than video of the participants in the video conference. For example, decision engine 382 may determine that information related to a new participants should be shown on the display as it is being discussed during the video conference. Alternatively, decision engine 382 may determine that other information (e.g., an alert that a notification is being sent, a request for confirmation to send a notification, and/or information related to a moderator, etc.) should be shown on the display because it is relevant to what is being discussed during the video conference.

In further embodiments, the decision engine 382 may send notifications to new participants. For example, decision engine 382 can determine that a participant should receive information related to the video conference and send the information. The decision engine 382 may send information to a new participant who is not currently participating in the video conference. The notifications can include a notification to a new participant that is an invitation to join the video conference. The invitation to join may be sent automatically, or after a confirmation is received from a human, and may be sent by any channel or combination of channels (e.g., via text message, email, and/or phone call, among others). The notifications may contain any type of information; for example, a notification may contain an invite to join along with a context of what was discussed in the meeting that was related to the invite to join (e.g., a context of the meeting topics that are relevant to the new participant).

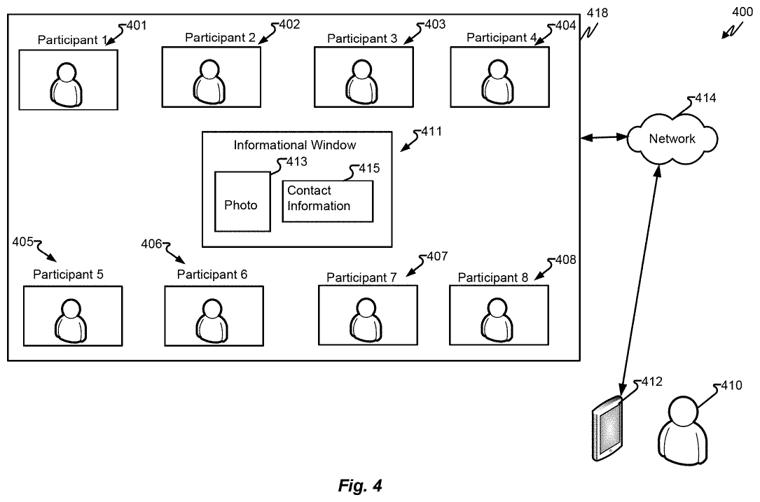

FIG. 4 is a screen 400 depicting additional illustrative details of methods and systems in accordance with at least some embodiments of the present disclosure. In some aspects, the components shown in FIG. 4 may correspond to like components discussed in other figures disclosed herein.

In FIG. 4, screen 400 shows a display 418 showing different participants of a video conference and highlighted information displayed in an informational window 411. In various embodiments, the participant displays (e.g., showing participant 1-8 401-408) may be referred to herein as windows; thus, the participants of the video conference are shown within windows within the display 418. The display 418 may be referred to as a window, a view, or a layout and may take up an entirety or only a portion of a screen 400. In FIG. 4, there are eight participants participating in the video conference, including participant 1 401, participant 2 402, participant 3 403, participant 4 404, participant 5 405, participant 6 406, participant 7 407, and participant 8 408.

In some aspects, display 418 is displayed to each of the participants in the video conference (e.g., on a communication device of participant 1 401, on a communication device of participant 2 402, on a communication device of participant 3 403, on a communication device of participant 4 404, on a communication device of participant 5 405, on a communication device of participant 6 406, on a communication device of participant 7 407, and on a communication device of participant 8 408). In alternative embodiments, display 418 may be shown to only one or some of the participants of the video conference (e.g., different participants may be shown different layouts. The display 418 also shows informational window 411 containing photo 413 and contact information 415. The contact information 415 may be any type of information, including name, email, phone number, and/or user identification, among others. In some embodiments, the video conference may be able to connect with a new participant 410 via device 412 and network 414, as described herein.

In FIG. 4, the eight participants (e.g., participants 1-8 401-408) are engaged in a video conferencing session and discussing information that relates to a participant who may or may not be currently participating in the video conference (e.g., new participant 410). For example, in some embodiments, one or more of the participants 1-8 401-408 may be discussing a task that is related to a participant who is not currently connected to the video conference (e.g., a new participant). In accordance with various methods and systems disclosed herein, information discussed by one or more of participants 1-8 401-408 during the video conference may be monitored and analyzed (e.g., via artificial intelligence) and it may be detected, during the monitoring and in real-time, that one or more of the participant(s) of the video conference is discussing information (e.g., a task) that is external to the video conference (e.g., external information) and that the external information is accessible by the system. The external information may be a database of task information (e.g., information associated with a ticketing system such as Jira Software and Sibel) and may be determined by identification of the task within the discussion occurring in the video conference. For example, the systems and methods disclosed herein may determine content (e.g., key words associated content) within a video conference that is associated with an external system, and then access the external system to find information associated with the determined content, which may include identifications of one or more new participants.

As an illustrative example, a name or an identification number of one or more tasks may be mentioned during a discussion occurring within a video conference, and an analysis of the discussion may detect the spoken name or identification number of the task. The spoken name or identification number of the task may be used to search a ticketing system (e.g., Jira Software) to pull associated information related to the task. One or more new participants related to the task may be identified based on the information in the Jira repository. Thus, in certain aspects, the system accesses information related to the task, for example by accessing an external information database and finding one or more records related to the task. The system may analyze the record to determine identifying information that identifies a new participant who is associated with the task, such as new participant 410.

Using new participant 410 as an illustrative example, the system determines that the new participant 410 associated with the task is not a current participant of the video conference, e.g., that new participant 410 is not one of participants 1-8 401-408. The system determines that the information associated with new participant 410 should be displayed as highlighted information in the video conference on display 418 based on the discussion that is occurring. the system obtains information related to the new participant 410 that includes a photo 413 of the new participant 410 and contact info 415 of the new participant 410. This information may be obtained from the same external information database or from one or more different external locations. The system displays the photo 413 and the contact information 415 in the informational window 411 during the relevant portion of the conversation of the video conference that the information related to the new participant 410 is being discussed. The informational window 411 may be managed (e.g., configured and displayed) automatically, without any interaction from a human user (including without any interaction from participants 1-8 401-408 or new participant 410).

As another illustrative example, the systems and methods disclosed herein may determine participant decisions based solely or in part on historical information (e.g., information stored in historical database 386). The system (e.g., participant decision engine 325) may determine that a meeting moderator will intervene once a video conference, or a discussion within a video conference, is going beyond a set timeframe. This may be a certain amount of time (e.g., 10 minutes, 20 minutes, etc.) and/or a time of day (e.g., 9:10 am-9:20 am, past 9:30 am, etc.). In such instances, if the historical information shows that a moderator will intervene under one or more specified circumstances (e.g., decision engine 382 determines that information in historical database 386 shows that a moderator will intervene in the video conference under certain circumstance(s)), then the system may determine a participant decision (e.g., via a decision saved in participant decisions 382). In some cases, when a timeframe associated with a video conference is exceeding a pre-determined timeframe, then the participant display may be changed to show information associated with a moderator of the video conference (e.g., a picture of the moderator, a video of the moderator, and/or contact information associated with the moderator).

As yet another illustrative example, the systems and methods disclosed herein may determine participant decisions based solely or in part on user information (e.g., user profile information). The system may manage user profile information, including creating and/or accessing user profiles, and user the information to determine participant decisions associated with a video conference. As an example, a system (e.g., a participant decision engine 325) may access user profile data (e.g. user profile data saved in external information 372) and search for information related to discussion topics as the discussion topics are detected during the video conference. For example, if participants in a video conference are discussing a security question, the system (e.g., participant decision engine 325) may search external information (e.g., external information 372) for user profiles that indicate that a user is an expert on security as it relates to the security question. The system may determine that the user who is an expert on security is a new participant because they are not participating in the video conference, and may decide (e.g., via a decision saved in participant decisions 382) to highlight information associated with the new participant (e.g., on one or more participant displays as the discussion in the video conference is occurring (e.g., a picture of the new participant, a video of the new participant, and/or contact information associated with the new participant).

Thus, in some embodiments, the system determines that certain information should be displayed during relevant portions of the discussion, and adjusts the display 400 so that the display 418 shows the information (e.g., in real-time) during relevant portions of the discussion as they occur in real-time. In various embodiments, the information highlighted may change based on the real-time analysis of the discussion, including based on any information retrieved in association with the analysis.

Advantageously, the video conference participants (e.g., participants 1-8 401-408) are shown information about the new participant 410 in informational window 411 and the information shown relates to the current discussion occurring within the video conference (e.g., discussion about a task related to the new participant 410). The display of the information in information window 411 may allow participants 1-8 401-408 to easily and quickly view and access information about the new participant 410 and thereby improve the knowledge of participants 1-8 401-408 regarding the current discussion occurring in the video conference. This can increase participant satisfaction and efficiency by, for example, helpfully reducing misunderstandings about the topics of discussion or the related users (and thereby also reducing questions from participants during or after the video conference), as well as improving communications and information sharing.

In further embodiments, methods and systems include contacting one or more new participants (e.g., to provide information to the new participant(s), to invite the new participant(s) to join the video conference, etc.). Thus, in additional and/or alternative embodiments, the informational window 411 may include one or more options to contact and/or notify one of more new participant(s) (e.g., including new participant 410) about the video conference, discussion(s) within the video conference, result(s) of the video conference, and/or any other information associated with the video conference. A notification may be sent to the new participant(s) in any manner and may contain any type of or amount of information (such as a summary of the discussion topic, a comprehensive overview of the video conference results, a voice-to-text transcript, a short statement that a task related to the new participant was discussed, etc.). Notifications can be in any communication format (e.g., via email, text messaging, or other type of messaging or communication).

Information sent to new participant(s) may be (or may include) an invitation to join the video conference). In some aspects, the option(s) can include a button to invite the new participant(s) to the video conference that is selectable by one or more of the participants 1-8 401-408 and may automatically connect the new participant(s) to the video conference when selected. Also, the option(s) provided to the one or more participants (e.g., via information window 411) may include notification options to notify the new participant(s) of the discussion occurring in the video conference and/or other information related to the video conference that the methods and/or systems determine should be sent to the new participant(s).

In some embodiments, information that is helpful to the video conference may be automatically displayed on display 418 during the video conference. For example, if it would be helpful to have a moderator join the video conference, or if it would be helpful to warn participants that a moderator may join the video conference, then a moderator may be joined to the video conference or information associated with the moderator may be displayed on display 418. The moderator may be a current participant of the video conference, or may be a new participant. For example, if the video conference itself is taking a longer time than scheduled (or a discussion within the video conference is taking longer than it is supposed to), or if the participants need to get back on topic to stay on a scheduled timeframe within the video conference, a moderator may be joined to the video conference, or information to warn the participants may be shown (e.g., a picture of the moderator). Thus, in some embodiments, informational window 411 may show information associated with the moderator, such as a photo 413 of the moderator and contact information 415 of the moderator. Informational window 411 may show information stating why the moderator is being shown at that point in time (e.g., a textual message explaining that the meeting is exceeding a scheduled timeframe). Information displayed in informational window 411 may change at any time during the video conference.

As discussed herein, the managing of the display processing and/or notification processing may be done by a participant decision engine, and the resulting decisions about changes to a display and/or notifications may be provided by a decision engine (e.g., decision engine 382) to a participant decisions component (e.g., participant decisions 384) and sent to one or more nodes via a communication server (e.g., communication server 321). As can be appreciated, the methods and systems shown and discussed in FIG. 4 may enable one or more of the participants (e.g., participants 1-8 401-408) to quickly and easily be able to see information related to discussion points occurring in the video conferencing session. In addition, the methods and systems shown and discussed in FIG. 4 may enable automatic invitations to relevant new participant(s) to join the video conference, and/or automatic notifications of new participant(s) about information related to the video conference. The invitations and notifications may be fully automated or partially automated. For example, in various embodiments, one or more elements human interaction may be combined with one or more automated elements of the methods and systems disclosed herein (e.g., a new participant may be notified of a discussion occurring in a video conference; however, a moderator of the video conference may need to confirm that an invitation to join should be sent to the new participant).

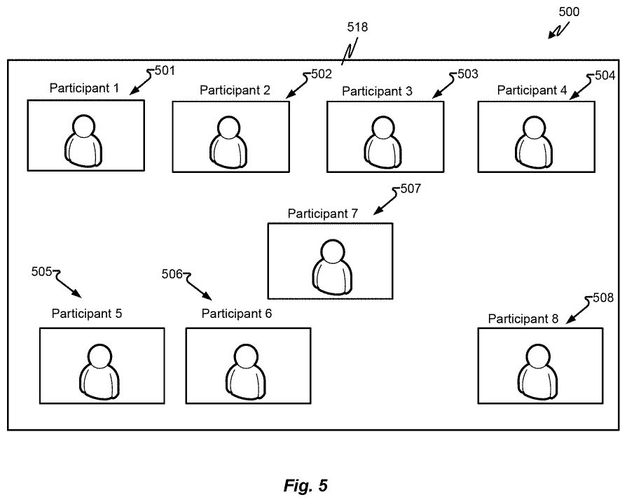

FIG. 5 is a screen 500 depicting additional illustrative details of methods and systems in accordance with at least some embodiments of the present disclosure. In some aspects, the components shown in FIG. 5 may correspond to like components discussed in other figures disclosed herein. In FIG. 5, screen 500 shows a display 518 showing different participants of a video conference in one window for each participant. In FIG. 5, there are eight participants participating in the video conference, including participant 1 501, participant 2 502, participant 3 503, participant 4 504, participant 5 505, participant 6 506, participant 7 507, and participant 8 508.

In FIG. 5, the participants (e.g., participants 1-8 501-508) are engaged in a video conferencing session and are discussing information that relates to participant 7 507. However, participant 7 507 is not currently talking. In some embodiments, participant 7 507 may be on mute, or may be switching their mute on and off during the discussion. In other embodiments, participant 7 507 may not have a video feed turned on, and so the image shown for participant 7 507 is only a picture of participant 7 507. The systems and methods described herein analyze the conversation occurring during the video conference and determine that, during a timeframe associated with the display 518 being shown to at least one of the video conference participants, the discussion occurring in the video conference is focused on topics that relate only to participant 7 507 (e.g., the topics being discussed do not relate to participants 1-6 501-506 or participant 8 508). Thus, based on the analysis and the determination that participant 7 507 is the focus of the conversation, the display 518 is changed to highlight participant 7 507 by displaying participant 7 507 in the middle of the display 518. In some aspects, display 518 is shown to all participants in the video conference so that each of participants 1-8 501-508 see the display 518 that shows participant 7 507 displayed in the middle of the screen on all of their respective nodes (e.g., communication devices).

In some embodiments, the display shown in FIG. 5 may correspond to a same video conference that is shown and discussed in other figures disclosed herein. Thus, during a single video conference, the configuration of the display of the participants of the video conference may change as the video conference progresses. For example, as the video conference progresses, the methods and systems disclosed herein may monitor the content of the video conference to determine what should appear on the display during certain timeframes within the video conference, as well as how the information shown on the display should appear. Continuing with the illustrative example, during a first timeframe within the video conference, informational window 411 (as shown in FIG. 4) may be highlighted on the display (e.g., shown in the middle of the display) based on the information being discussed that relates to the information shown in informational window 411 during the first timeframe. However, at a second timeframe within the video conference, participant 7 507 (as shown in FIG. 5) may be highlighted on the display (e.g., shown in the middle of the display) based on the information being discussed that is associated with participant 7 507 during the second timeframe. The content of the video conference may be monitored in any manner. The content may be monitored in real-time, so that the display changes in real-time to reflect the content being discussed at that point in time. In further embodiments, the display 500 shown in FIG. 5 may be a different video conference then that shown and discussed in other figures disclosed herein.

In some embodiments shown in FIG. 5, the display may be showing a virtual teaching experience. Thus, participants 1-8 501-508 may be students and/or one or more teachers who are participating in a discussion (e.g., the video conference may be a class where the teacher is calling on students and conducting a discussion). In this illustrative example, participant 7 507 may be a student who was called upon by the teacher. Participant 7 507 may not be talking at the time that the window displaying participant 7 507 is shown in the middle of the display 718 (e.g., the teacher may be finishing stating the question at the time that participant 7 507 is highlighted or the class may be waiting for a response from participant 7 507); however, participant 7 507 may be highlighted regardless. The systems and methods disclosed herein may detect a participant who is the focus or object of the discussion and highlight that participant's window even if the participant is not currently speaking or moving, and even if the participant has their microphone muted. Thus, the methods and systems disclosed herein can advantageously highlight a participant who is the focus of a discussion regardless of whether the participant is talking at the time, and even if the participant is on mute. Therefore, using the embodiments disclosed herein, other participants in the video conference (such as other students and/or teachers), may have their attention brought to, and be more aware of, the participant who is the focus of the discussion.

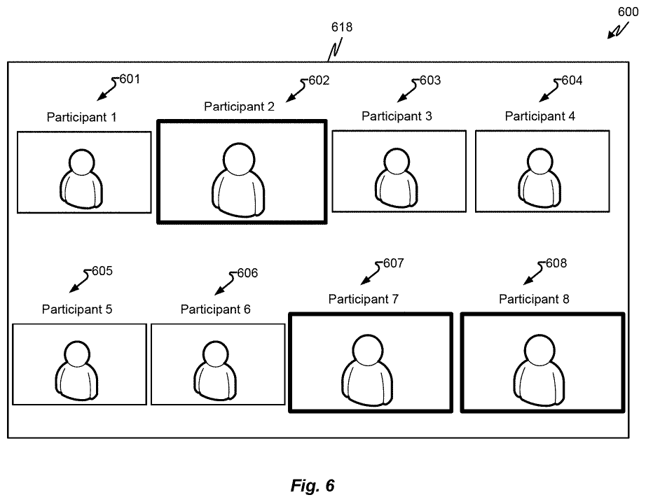

FIG. 6 is a screen 600 depicting additional illustrative details of methods and systems in accordance with at least some embodiments of the present disclosure. In some aspects, the components shown in FIG. 6 may correspond to like components discussed in other figures disclosed herein.

In FIG. 6, a participant display 618 shows multiple participants that are highlighted during a video conference. In particular, participant 2 602, participant 7 607, and participant 8 608, are highlighted in the display 618. Although three participants are highlighted, not all three may be talking while they are highlighted. As an illustrative example, participant 2 602, participant 7 607, and participant 8 608, may be discussing a certain topic in the video conference during a timeframe when the display 618 is shown, yet not all of the three participants may be talking during the timeframe (e.g., only participant 7 607 may be talking during some time of the timeframe and only participant 8 608 may be talking during other times of the timeframe while participant 2 602 does not speak at all). The methods and systems disclosed herein can determine that all three participants are involved in the discussion that is occurring during a timeframe, and therefore all three participants (e.g., participant 2 602, participant 7 607, and participant 8 608) are highlighted on display 618 during the timeframe. As discussed herein, even if one or more of the participants is on mute or not speaking, all three participants may be highlighted at a same time while the discussion is occurring during the video conference because all three participants are relevant participants.

In some embodiments, FIG. 6 shows a number of participants identified as relevant by accessing external information. For example, a discussion may occur within a video conference that contains a list of items from a ticketing system such as Jira Software. The system may determine that a display of the video conference should be managed based on the mention of the list of items, and the system may pull data related to the list of items from Jira Software for analysis. Based on the data pulled and analyzed, the system may determine that participant 2 602, participant 7 607, and participant 8 608 are all responsible for the list of items being discussed in the video conference, and the system may determine that these participants should be highlighted. Thus, during a discussion of the list of items, participant 2 602, participant 7 607, and participant 8 608 may all be highlighted on the display because it was determined that they were the participants that are responsible for the list of items.

As shown in FIG. 6, the participants who are highlighted (e.g., participant 2 602, participant 7 607, and participant 8 608) are highlighted by having their respective windows enlarged as compared to the windows of participants who are not highlighted. Also, the windows of participant 2 602, participant 7 607, and participant 8 608, are highlighted by having frames around each of their respective windows visually changed (e.g., thickened or bolded) as compared to the windows of participants who are not highlighted. Thus, advantageously, the participants of the video conference can advantageously easily and quickly focus on the participants (or know the identities of the participants) who are discussing a current topic in the video conference. This can advantageously reduce confusion and improve communication during the video conference.

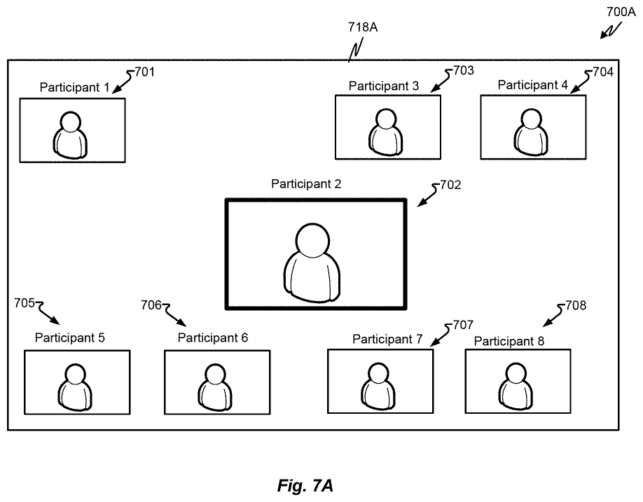

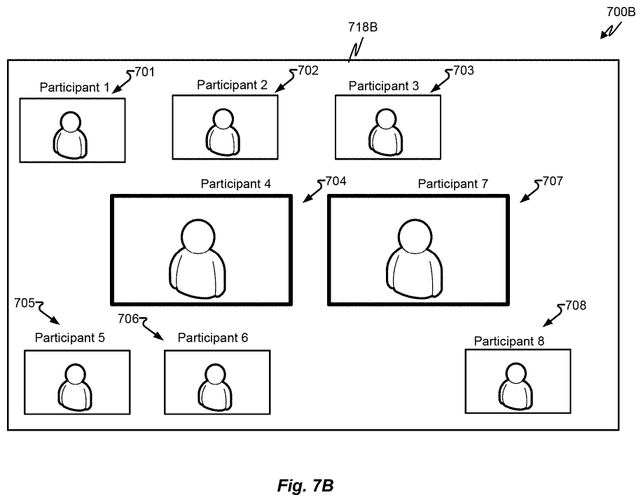

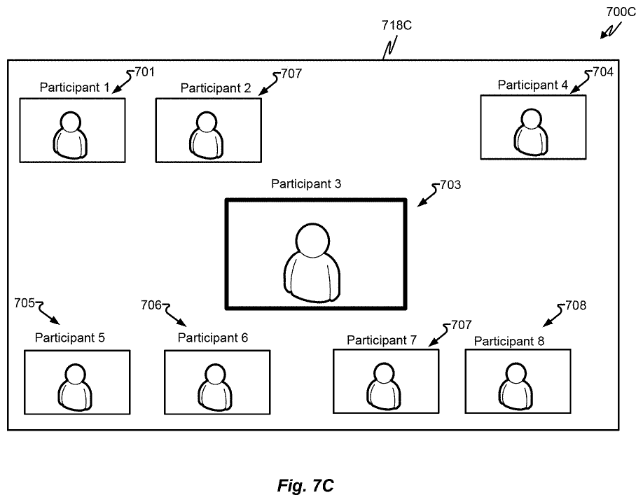

FIGS. 7A-C show a display 700A-C, respectively, depicting additional illustrative details of methods and systems in accordance with at least some embodiments of the present disclosure. In some aspects, the components shown in FIGS. 7A-C may correspond to like components discussed in other figures disclosed herein.

FIGS. 7A-C show, in some embodiments, how a display (e.g., display 718A-C) may change during a time frame occurring within a single video conference, or during an entirety of a single video conference. In accordance with embodiments discussed herein, the display 718A-C may be managed as a discussion occurring in the video conference changes. The display 718A-C may be managed by analyzing the information associated with the video conference, even information as it happens in real-time (for example, the discussion as it occurs while the participants are talking as the video conference progresses).

As an illustrative example, at a first point in time during the video conference, participant 2 702 may be discussing topics of conversation and an agenda that will occur during the video conference. The methods and systems described here in may detect that participant 2 702 is the only participant discussing the items during the timeframe, and therefore participant 2 702 may be the only participant highlighted in display 718A during the time of participant 2 702's discussion, as shown in FIG. 7A. As shown in FIG. 7A, participant 2 702 may be highlighted by not only being centered on display 718A but also by having a bold frame around the window that shows participant 2 702. After completing the discussion points, participant 2 702 may pass the discussion over to participants in charge of the next agenda item, which (in this illustrative example) is a presentation of participant 4 704 and participant 7 707.

At a point in time when the discussion changes from the focus on participant 2 702 to the presentation of participant 4 704 and participant 7 707, as shown in FIG. 7B, the methods and systems described herein may detect that participant 2 702 is no longer the focus of the video conference, and that participant 4 704 and participant 7 707 are now the focus as they present to the other participants. The system may thereby determine that these two participants should be highlighted on display 718B. As shown in FIG. 7B, participant 4 704 and participant 7 707 may be highlighted on display 718B by not only being centered on display 718B, but also by having a frame around each of the windows in which participant 4 704 and participant 7 707 are displayed bolded. In some embodiments, when participant 4 704 and participant 7 707 are done with presenting their presentation, they may pass the discussion on to the next topic, which may be a discussion by participant 3 703.

The methods and systems described herein may detect that participant 3 703 is the relevant speaker at this point in time during the video conference and may display participant 3 703 highlighted in the middle of display 718C, as shown in FIG. 7C. Participant 3 703 may be highlighted on display 718C by being centered on display 718C, by being enlarged to have a window that is larger than other participants, and by having a bold frame around the window displaying participant 3 703. Thus, advantageously, all of the participants in the video conference (including participant 3 703) can advantageously realize quickly that participant 3 703 is the participant who is currently the focus of the video conference discussion. Even if participant 3 703 is on mute or is not currently talking, participant 3 703 may be highlighted, or remain highlighted, on display 718C during an entirety of the discussion time during which the discussion is focused on participant 3 703.

Therefore, as shown in FIGS. 7A-C, the methods and systems described herein may advantageously highlight relevant participants during a video conference session, even as the discussion changes and as one or more participants within a discussion change. Relevant participants may be highlighted even if they are on mute or not currently talking. Other advantages of the embodiments describe herein include that participants may advantageously increase participation within video conference due to feeling more involved as they see the screen change (with relevance to the discussion) as the video conference progresses. Also the participants may have an improved understanding of who the relevant participants are within the video conference 718 at different points in time within the video conference (even if they have not been paying attention or if they had to step away for a minute and missed the change in discussion that occurred).

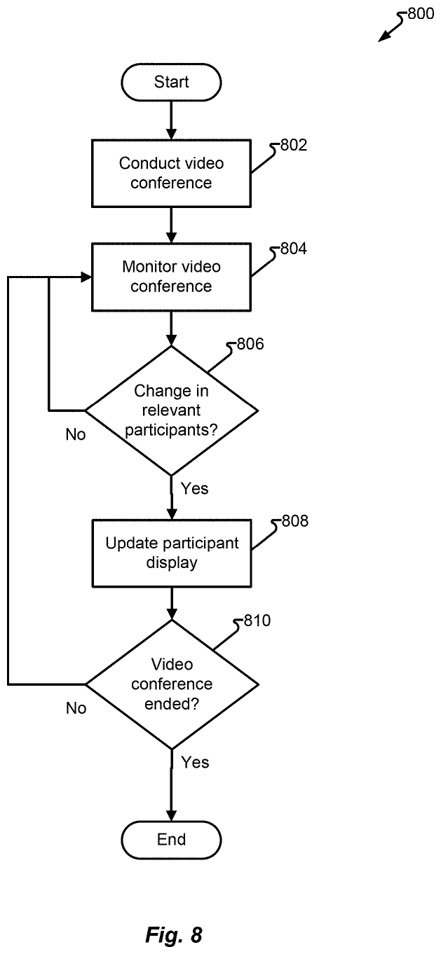

FIG. 8 shows an illustrative first process in accordance with various embodiments of the present disclosure. In some aspects, the components shown in FIG. 8 may correspond to like components discussed in other figures disclosed herein.

In FIG. 8, the process starts with a video conference being conducted at step 802. The video conference may have information associated with the video conference (e.g., one or more video feeds and/or one or more audio feeds) that is monitored as it occurs in step 804. The monitoring start at any point in time during the video conference, including from when the video conference begins or after the video conference begins, and it may include an entire time duration of the video conference or only one or more portions of time within the video conference.

During the monitoring of the video conference, the process may detect changes in relevant participants at step 806. For example, as the information associated with the video conference is monitored, the information may be analyzed to determine if participants who are currently relevant in the video conference change (e.g., spoken words and/or written words may be detected and analyzed to determine which participants are discussion, or are a focus of, the current topics of discussion occurring in the video conference). Thus, at step 808, the process may determine if information shown on a display to one or more participants of the video conference should change because one or more relevant participants at the respective timeframe of the video conference has changed. If there is no change in relevant participants detected then the video conference continues to be monitored at step 804; however, if there is a change in relevant participants detected at step 806, then the process proceeds to step 808.

If a change in relevant participants is detected, then the participant display is updated at step 808 to show the change in the relevant participants. In other words, participants who are no longer relevant to the current discussion occurring within the video conference are not highlighted (e.g., any highlighting features are removed from their respective windows) and participants who are relevant to the current discussion are highlighted. At step 810, it is determined whether the video conference has ended. If the video conference has not ended, the method returns to monitoring the video conference at step 804. If the video conference has ended, then the process 800 ends.

Thus, as shown and discussed in FIG. 8, the methods and systems described herein may advantageously update the participant display as one or more discussions occur in a video conference in order to show whichever participants are relevant at that point in time during the video conference. The video conference may be continuously and automatically monitored and the display may be continuously and automatically managed based on an analysis of information associated with the video conference (e.g., discussion occurring during the video conference). The management of the display, in some embodiments, may be partially based on human interactions (e.g., a human participant confirming an action suggested by the system in order for the action to be executed by the system).

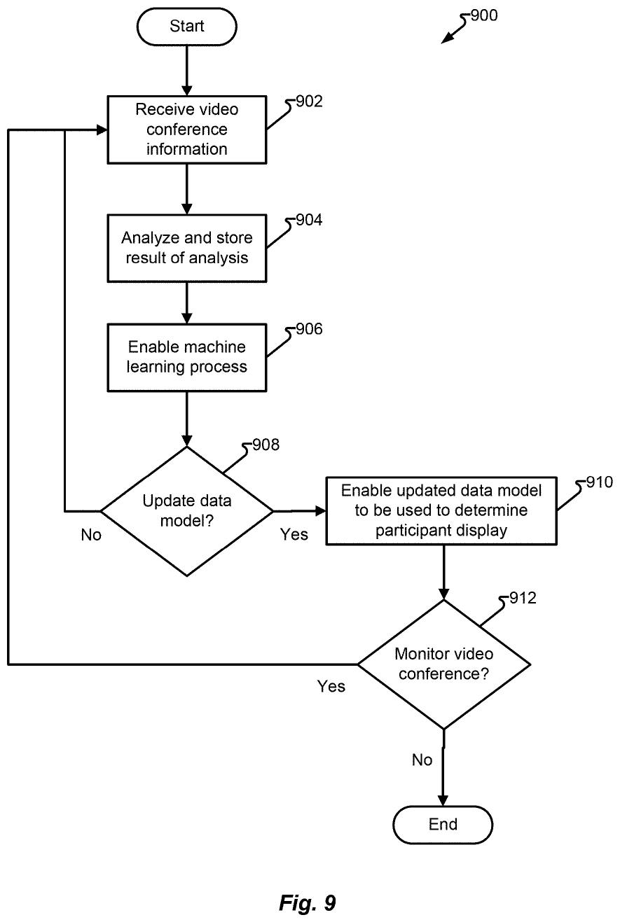

FIG. 9 shows an illustrative second process 900 in accordance with various embodiments of the present disclosure. In some aspects, the components shown in FIG. 9 may correspond to like components discussed in other figures disclosed herein. In FIG. 9, process 900 starts and information is received about a video conference at step 902. The information may be any information associated with the video conference, including audio data, video data, and image data, and may also include external information.

At step 904, video conference information, e.g., that received in step 902, is analyzed and stored. In some embodiments, the video conference information may be analyzed to determine how to manage one or more displays. The displays may be displays of a video conference that is currently occurring and from which the information from step 902 was received. In other embodiments, the displays may be displays not associated with a video conference that is related to step 902. The results of the analysis may be stored in a database associated with components described herein, such as the historical database 386, and the results may be stored immediately or after processing by the learning module 374 of the participant decision engine 325. The analysis of the information may allow the learning module 374 to learn and possibly update a data model (e.g., data model(s) 376) based on the video conference information received.

At step 906, the machine learning process is enabled (e.g., the participant decision engine 325) to access the historical database 386 and/or the participant decisions 384. Based on its access of the database(s), the participant decision engine 325 may update one or more data models (e.g., data model(s) 376) at step 908. The updated data models (e.g., data model(s) 376) may then be used by the participant decision engine 325 to process information received in the future (step 910). For example, the updated data models (e.g., data model(s) 376) may be used to manage one or more displays in the future. In some embodiments, the participant display may be managed for a video conference associated with the information received at step 902.

If it is determined that the data model should not be updated, then the process returns to step 902 and the video conference continues to be monitored. If the process determines that the data model should be updated at step 908, then the data model is updated at step 910. At step 912, it is determined if the video conference should continue to be monitored (e.g., if the video conference is still occurring, then it should be monitored). If the video conference should still be monitored, then the process returns to step 902 to receive additional video conference information. If the video conference should not be monitored, then the process ends.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may include a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally, or alternative, the machine-readable instructions may be accessible to the microprocessor and encoded in a media or device as magnetic fields, voltage values, charge values, reflective/non-reflective portions, and/or physical indicia.

In another embodiment, the microprocessor further includes one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may include, a central processing unit (CPU) with data values encoded in an instruction register (or other circuitry maintaining instructions) or data values including memory locations, which in turn include values utilized as instructions. The memory locations may further include a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may include task-specific allocation of processing tasks and/or shared or distributed processing tasks. In yet another embodiment, a microprocessor may execute software to provide the services to emulate a different microprocessor or microprocessors. As a result, first microprocessor, included of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically. They may also be performed continuously and semi-automatically (e.g., with some human interaction). They may also not be performed continuously.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit- switched network. In another embodiment, the components may be physical or logically distributed across a plurality of components (e.g., a microprocessor may include a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein including software are executed, or stored for subsequent execution, by one or more microprocessors and are executed as executable code. The executable code being selected to execute instructions that include the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to include a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A system, comprising:
at least one processor;
and
a network interface to enable the at least one processor to communicate via a network;
wherein the at least one processor:
conducts a video conference as a node on the network and communicates via the network with communication devices associated with remote participants;
stores a result of an analysis of the video conference in a data structure comprising video conference information; and
updates a data model used to automatically determine a participant decision based on the analysis of the data structure,
wherein the analysis of the video conference is an analysis of a conversation occurring during the video conference, wherein the result is a participant identification; wherein the at least one processor identifies a new participant based on the participant identification, wherein the new participant is not one of the remote participants, and wherein the participant decision comprises including highlighted information associated with the new participant in a participant display of each of the remote participants.

2. (canceled)

3. (canceled)

4. The system of claim 1, wherein the conversation is a verbal conversation.

5. The system of claim 4, wherein the analysis of the conversation comprises Natural Language Processing.

6. The system of claim 5, wherein the Natural Language Processing identifies at least two relevant participants.

7. (canceled)

8. (canceled)

9. (canceled)

10. (canceled)

11. The system of claim 1, wherein the participant decision further comprises sending a notification to the new participant.

12. The system of claim 1, wherein the result of the analysis further includes information that is external to the video conference; wherein the at least one processor identifies the new participant based on the information that is external, and wherein the participant decision comprises displaying a view highlighting an image of the new participant.

13. (canceled)

14. (canceled)

15. (canceled)

16. A method, comprising:
conducting a video conference over a network comprising a local node, utilized by a local participant, and remote nodes associated with remote participants;
storing a result of an analysis of the video conference in a data structure comprising video conference information;
updating a data model used to automatically determine a participant decision based on the analysis of the data structure,
wherein the analysis of the video conference is an analysis of a conversation occurring during the video conference,
wherein the result is a participant identification; and
identifying a new participant based on the participant identification,
wherein the new participant is not one of the remote participants, and
wherein the participant decision comprises including highlighted information associated with the new participant in a participant display of each of the remote participants.

17. (canceled)

18. (canceled)

19. The method of claim 16, further comprising:
enabling a machine learning process to analyze the data structure, wherein the analysis of the data structure is done by the machine learning process.

20. A system, comprising:
means to conduct a video conference on the network and communicate via the network with remote participants;
means to store a result of an analysis of the video conference comprising video conference information;
means to automatically determine a participant decision based on the analysis comprising the data structure information,
wherein the analysis of the video conference is an analysis of a conversation occurring during the video conference, wherein the result is a participant identification;
means to identify a new participant based on the participant identification,
wherein the new participant is not one of the remote participants, and
wherein the participant decision comprises including highlighted information associated with the new participant sent to the remote participants.

21. The method of claim 16, wherein the conversation is a verbal conversation.

22. The method of claim 21, wherein the analysis of the conversation comprises Natural Language Processing.

23. The method of claim 22, wherein the Natural Language Processing identifies at least two relevant participants.

24. The method of claim 16, wherein the participant decision further comprises sending a notification to the new participant.

25. The method of claim 16, wherein the result of the analysis further includes information that is external to the video conference,
the method further comprising identifying the new participant based on the information that is external, and
wherein the participant decision comprises displaying a view highlighting an image of the new participant.

26. The system of claim 20, wherein the conversation is a verbal conversation.

27. The system of claim 26, wherein the analysis of the conversation comprises Natural Language Processing.

28. The system of claim 27, wherein the Natural Language Processing identifies at least two relevant participants.

29. The system of claim 20, wherein the participant decision further comprises sending a notification to the new participant.

30. The system of claim 20, wherein the result of the analysis further includes information that is external to the video conference,
the means to identify further includes identifying the new participant based on the information that is external, and
wherein the participant decision comprises displaying a view highlighting an image of the new participant.
